(19) United States
(12) Patent Application Publication
(10) Pub. No.: US 2025/0085429 A1
(43) Pub. Date: Mar. 13, 2025

(54) POSE GENERATION VIA LIDAR SENSOR MEASUREMENTS

(71) Applicants: Ford Global Technologies, LLC, Dearborn, MI (US); THE REGENTS OF THE UNIVERSITY OF MICHIGAN, Ann Arbor, MI (US)

(72) Inventors: Seth Isaacson, Ann Arbor, MI (US); Pou-Chun Kung, Ann Arbor, MI (US); Katherine Skinner, Ann Arbor, MI (US); Manikandasriram Srinivasan Ramanagopal, Pittsburgh, PA (US); Ramanarayan Vasudevan, Ann Arbor, MI (US)

(73) Assignees: Ford Global Technologies, LLC, Dearborn, MI (US); THE REGENTS OF THE UNIVERSITY OF MICHIGAN, Ann Arbor, MI (US)

(21) Appl. No.: 18/463,733

(22) Filed: Sep. 8, 2023

(51) Int. Cl. G01S 17/931; B60W 60/00; G01S 17/89

(52) U.S. Cl. CPC G01S 17/931; B60W 60/001; G01S 17/89; B60W 2420/408

(57) ABSTRACT

A computer includes a processor and a memory, and the memory stores instructions executable by the processor to generate a set of points from a measurement scan obtained by a lidar sensor and to generate an expected termination distance of the set of points based on a neural implicit representation of the set of points. The instructions may additionally be to compute a loss function that includes a relatively low margin correlated with the variance or standard deviation of a training distribution centered at a learned point of the set of points based on the expected termination distance of the learned point, the learned point being learned by the neural implicit representation. The instructions may additionally be to generate a keyframe from the set of points and to generate a pose of the lidar sensor based on the keyframe.

### BACKGROUND

Modern vehicles typically include a variety of sensors. Some sensors detect static or moving objects external to the vehicle, such as other vehicles, lane markings of a roadway, traffic lights and/or signs, animals, natural objects, etc. Types of sensors for vehicles include radar sensors, ultrasonic sensors, scanning laser range finders, and light detection and ranging (lidar) devices.

### BRIEF DESCRIPTION OF THE DRAWINGS

FIG. 1 is a block diagram of an example vehicle.

FIG. 2 is a diagram showing processing of lidar sensor measurements and rendering of objects of a scene external to a lidar sensor.

FIG. 3A is a graph showing sample weights resulting from a query to a neural implicit representation and distances to an unlearned measurement point.

FIG. 3B is a graph showing sample weights resulting from a query to a neural implicit representation and distances to a learned measurement point.

FIG. 4A depicts a scene external to a lidar measurement system.

FIG. 4B is a representation of the image of FIG. 4A obtained via lidar measurement points.

FIG. 5 is a flowchart for a method of generating pose via lidar measurements.

### DETAILED DESCRIPTION

This disclosure describes techniques to compute pose of a sensor (e.g., a lidar sensor) utilizing a representation of a scene obtained via output signals from the lidar sensor. In an example, a scene can be represented using a multilayer perceptron that implements a neural implicit representation of the scene. In an example, a neural implicit representation includes characteristics of a neural radiance field with the exception that a neural radiance field operates utilizing camera-captured images, which may then be viewed from perspectives that were not included in a training data set. In contrast, a neural implicit representation, as described herein, operates without radiance estimates, relying, at least in some instances, on measurements obtained utilizing a lidar sensor (i.e., without utilizing output data from a camera).

As described herein, a neural implicit representation operates to model a geometry of a scene via training of a neural network, which, for example, can be a multilayer perceptron trained to implicitly represent a scene utilizing output signals representing lidar measurements obtained during a lidar measurement scan. In this context, a multilayer perceptron means a fully connected feed-forward artificial neural network with at least three layers (input, output, and at least one hidden layer). In an example, the input layer operates to receive a query (e.g., [symbol] (sᵢ; Θ)), and an output layer operates to provide a decision or prediction responsive to the received query. The combination of the input, hidden, and output layers of the multilayer perceptron operates as a computing resource and is capable of approximating many continuous or discontinuous functions. In this context, a “function” means a three-dimensional function (e.g., F(x,y,z)) that expresses a three-dimensional location (e.g., an x-coordinate, a y-coordinate, and a z-coordinate). In an example, a volume density for each point of the scene can be rendered with respect to a viewing location by the multilayer perceptron. In an example, the function may be with respect to a novel pose (e.g., an x-coordinate, a y-coordinate, a z-coordinate, and rotations about the x, y, and z coordinate axes) of a lidar sensor (e.g., lidar sensor 108A). As described further hereinbelow, utilizing a multilayer perceptron, a scene can be represented via set of discrete points obtained via a measurement scan conducted by a lidar sensor. In an example, at each point of the set of points, a density value can indicate whether that point is occupied (i.e., filled by an object) or unoccupied (i.e., free space, sky, or another location at which a reflected signal transmitted by the lidar sensor has not been detected).

In an example, a computer can be programmed to train the multilayer perceptron implementing the neural implicit representation utilizing successive sampling iterations. In response to the successive sampling iterations, a relatively low margin (ε) can be assigned to a “learned” point, which, in this context, means a lidar-measured point in a scene that has been previously determined to be occupied or unoccupied by the neural implicit representation. Also in this context, a higher margin (ε) can be assigned to a point (e.g., an unlearned point) in a scene that has not been previously determined to be occupied or unoccupied by the neural implicit representation. Also in this context, a margin (ε) can be correlated with the variance or standard deviation of a training distribution centered at the point (e.g., a learned point or an unlearned point). Accordingly, in response to successive sampling iterations, lidar measurements of points representing the geometry of a scene can converge with decreased “loss,” which, in this context, means a discrepancy between actual three-dimensional scene geometry and the geometry predicted via the neural implicit representation. In a similar vein, a “loss function” means a function that expresses a discrepancy (e.g., an error) between a density value of a point measured via a lidar sensor (e.g., 108A) and a predicted or expected density as computed by a multilayer perceptron. As described herein, by leveraging data with respect to points learned by the multilayer perceptron during previous lidar measurement scans, the loss in the neural implicit representation of points of the scene can be reduced by the neural implicit representation being informed of such previous measurements.

In an example, in response to successive sampling iterations, lidar measurements can be utilized to generate or compute the pose of the lidar sensor based on a neural implicit representation of a scene. Pose of the lidar sensor can be refined in response to additional keyframes, which may operate to further inform the neural implicit representation, thereby further reducing loss between actual three-dimensional scene geometry and geometry predicted by the neural implicit representation. In an example, after computing and/or refining the pose of the lidar sensor, the generated and/or refined pose may be transmitted to a vehicle autonomous driving application of a vehicle (e.g., vehicle 100) on which the lidar sensor (e.g., lidar sensor 108A) is mounted. The vehicle can then execute motion planning as part of an autonomous/semi-autonomous vehicle driving applications. In an example, vehicle pose computation and/or vehicle motion planning can be conducted in an absence of input signals from a camera, such as a camera mounted on vehicle 100.

An example system can include a computer having a processor and a memory, the memory including instructions executable by the processor to generate a set of points from a measurement scan obtained by a lidar sensor. The instructions can further be to generate an expected termination distance of the set of points based on a neural implicit representation of the set of points and to compute a loss function that includes a relatively low margin correlated with a variance or standard deviation of a training distribution centered at a learned point of the set of points based on the expected termination distance of the learned point, the learned point being learned by the neural implicit representation. The instructions can be further to generate a keyframe from the set of points and to generate a pose of the lidar sensor based on the keyframe.

In an example, the instructions to generate the pose of the lidar sensor can additionally include instructions to modify the pose of the lidar sensor to align with the implicit representation of the scene.

In an example, the instructions to compute the loss function can include instructions to assign a relatively high margin correlated with a variance or standard deviation of a training distribution centered at an unlearned point of the set of points based on the unlearned point being unlearned by the neural implicit representation.

In an example, the instructions can additionally be to transmit the generated pose of the lidar sensor to an autonomous vehicle driving application.

In an example, the instructions can additionally be to execute motion planning by the autonomous vehicle driving application based on the generated pose.

In an example, the computed loss can be based on a combination of primary loss and opacity loss of the learned point.

In an example, the instructions to compute the loss function include instructions to compute a depth loss of the learned point, in which the depth loss represents a difference between an expected distance to the learned point based on the neural implicit representation and a distance extracted from the measurement scan.

In an example, the instructions to compute the loss function can include instructions to compute a gradient of the loss function, and to include instructions to utilize the computed gradient to update generated pose estimates and weights of the neural implicit representation via gradient descent to reduce a magnitude of the loss function.

In an example, the instructions can additionally be to compute the margin for the learned point based on the neural implicit representation of the learned point and a weight of the learned point derived from the measurement scan.

In an example, the instructions can additionally be to compute the margin for both learned and unlearned points based on the neural implicit representation of the learned and unlearned points and a weight of the learned or unlearned point derived from the measurement scan.

In an example, the instructions can additionally be to assign a minimum margin to the learned point responsive to the assigned margin being less than a first threshold value.

In an example, the instructions can additionally be to assign a maximum margin to the learned point responsive to the assigned margin being greater than a second threshold value.

In an example, the instructions can additionally be to assign a zero weight to any point of the set of points responsive to an absence of a returned signal transmitted during the measurement scan.

In an example, the instructions can additionally be to generate a mesh representation of the measurement scan based on the neural implicit representation of the set of points.

In an example, the neural implicit representation can include a continuous function with respect to viewing locations of the lidar sensor measurement scan.

In an example, the neural implicit representation can include a continuous function that represents three-dimensional scene geometry.

In an example, a method can include generating a set of points from a measurement scan obtained by a lidar sensor and generating an expected termination distance of the set of points based on a neural implicit representation of the set of points. The method can additionally include computing a loss function that includes a relatively low margin assigned to a learned point of the set of points based on the expected termination distance of the learned point, the learned point being learned by the neural implicit representation. The method can additionally include generating a keyframe from the set of points and generating a pose of the lidar sensor based on the keyframe.

In an example, the method can additionally include assigning a relatively high margin to an unlearned point of the set of points based on the unlearned point being unlearned by the neural implicit representation.

In an example, the method can additionally include transmitting the updated pose of the lidar sensor to an autonomous vehicle driving application.

In an example, the method can additionally include executing motion planning by the autonomous vehicle driving application based on the generated pose.

In an example, the method can additionally include assigning a zero weight to any point of the set of points based on an absence of a returned signal received in response to a signal transmitted during the measurement scan.

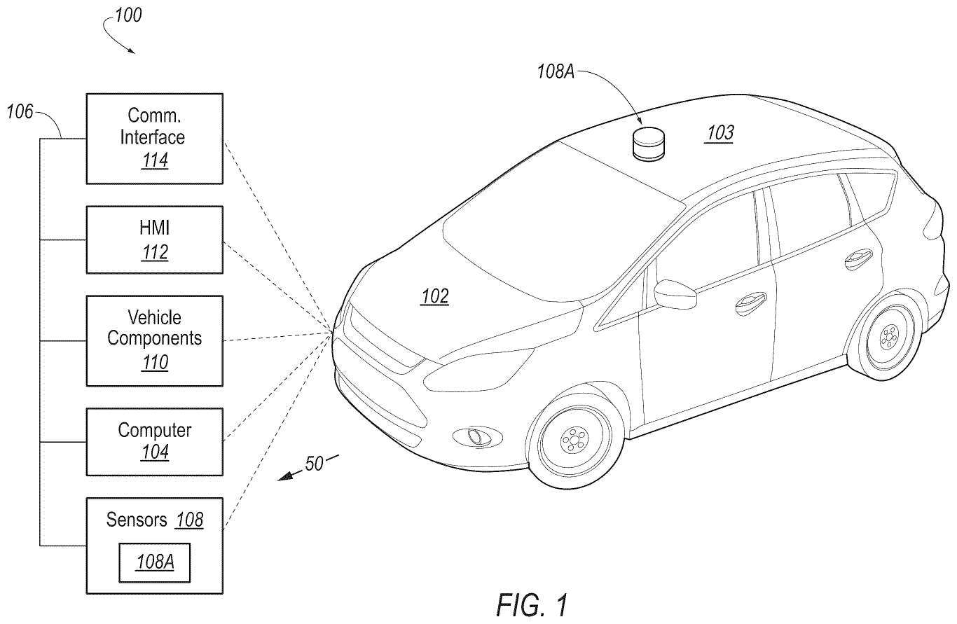

With reference to FIG. 1, vehicle 100 may be any passenger or commercial automobile such as a car, a truck, a sport utility vehicle, a crossover, a van, a minivan, a taxi, a bus, etc. Vehicle 100 can include computer 104, communications network 106, vehicle components 110, human-machine interface (HMI) 112, communications interface 114 (e.g., to provide Wi-Fi communications, communications with a satellite or terrestrial network, communications with other vehicles, etc.), and sensor set 108. Sensor set 108 may include a lidar scanner or other lidar-based measurement system, as indicated by lidar sensor 108A, which may operate to determine a distance between lidar sensor 108A and any static or moving objects in the driving environment of vehicle 100 as the vehicle proceeds along a path 50. Sensor set 108 can include other sensors, such as radar sensors, ultrasonic sensors, vehicle navigation sensors (e.g., sensors of a satellite positioning system), etc.

Vehicle components 110 includes a propulsion system to translate stored energy (e.g., gasoline, diesel fuel, electric charge) into motion to propel vehicle 100. Vehicle components 110 may include a conventional vehicle propulsion subsystem, for example, a conventional powertrain including an internal-combustion engine coupled to a transmission that transfers the torque generated by the engine to the wheels of vehicle 100. Vehicle components 110 can also include a hybrid powertrain that utilizes elements of the conventional powertrain and an electric powertrain; or may include any another type of powertrain. Vehicle components 110 can include an electronic control unit (ECU) or the like that is in communication with, and/or receives input from, computer 104 and/or a human operator. The human operator may control the propulsion system via, e.g., a pedal and/or a gear-shift lever.

Vehicle components 110 can include a conventional vehicle steering subsystem to control the turning of the wheels of vehicle 100. The steering subsystem may include rack-and-pinion steering members with electric power-assisted steering, a steer-by-wire system, or another suitable system. The steering subsystem can include an electronic control unit (ECU) or the like that is in communication with and receives input from computer 104 and/or a human operator. The human operator may control the steering subsystem via, e.g., a steering wheel.

HMI 112 presents information to and receives information from an operator of vehicle 100. HMI 112 may include controls and displays positioned, for example, on an instrument panel in a passenger compartment of vehicle 100 or may be positioned at another location that is accessible to the operator of vehicle 100. HMI 112 can include dials, digital readouts, screens, speakers, etc., for providing information to the operator of vehicle 100. HMI 112 can include buttons, knobs, keypads, microphones, and so on for receiving information from the operator.

Computer 104 of vehicle 100 can include a microprocessor-based computing device, e.g., a generic computing device, which includes a processor and a memory, an electronic controller or the like, a field-programmable gate array (FPGA), an application-specific integrated circuit (ASIC), a combination of the foregoing, etc. In an example, a hardware description language such as VHDL (VHSIC (Very High Speed Integrated Circuit) Hardware Description Language) can be utilized in electronic design automation to describe digital and mixed-signal systems, such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. Computer 104 can thus include a processor, a memory, etc. A memory of computer 104 can include a tangible media for storing instructions executable by the processor as well as for electronically storing data and/or databases. Alternatively or in addition, computer 104 can include structures such as the foregoing by which programming is provided. In an example, computer 104 can be multiple computers coupled together to operate as a single computing resource.

Computer 104 may transmit and receive data through communications network 106. Communications network 106 can include, e.g., a controller area network (CAN) bus, Ethernet, WiFi, Local Interconnect Network (LIN), onboard diagnostics connector (OBD-II), and/or any other wired or wireless communications network. Computer 104 may be communicatively coupled to lidar sensor 108A, vehicle components 110, HMI 112, communications interface 114 and other vehicle systems and/or subsystems via communications network 106.

Lidar sensor 108A may include a scanning lidar emitter and receiver, which can operate by detecting distances to objects by emitting laser pulses at a particular wavelength and measuring the time of flight for the pulse to travel to an object, such as a static or moving object in the driving environment of vehicle 100, and back to lidar sensor 108A. Lidar sensor 108A can also include an emitter that transmits a continuous beam and measures the phase shift in a received signal. Thus, lidar sensor 108A can include any suitable type of scanning lidar signal emitter and receiver, which may cooperate to provide lidar sensor measurements to computer 104. Accordingly, in an example, lidar sensor 108A can be arranged to include a stack of individual lidar signal emitters and receivers oriented in an upward direction with respect to vehicle structure 103, to which lidar sensor 108A is mounted. In such an arrangement, lidar sensor 108A can be scanned to transmit lidar signals and to receive lidar signals reflected from objects located in any direction with respect to vehicle body 102. In an example, lidar sensor 108A can execute a sweeping lidar scan to detect objects external to vehicle body 102 by scanning the lidar sensor first in a direction to the right of vehicle body 102, followed by areas in a vehicle-forward direction with respect to vehicle body 102, and terminating by scanning areas to the left of vehicle body 102. In other examples, lidar sensor 108A can include a spindle-type lidar, solid-state lidar, a flash lidar, etc.

### Exemplary System Operations

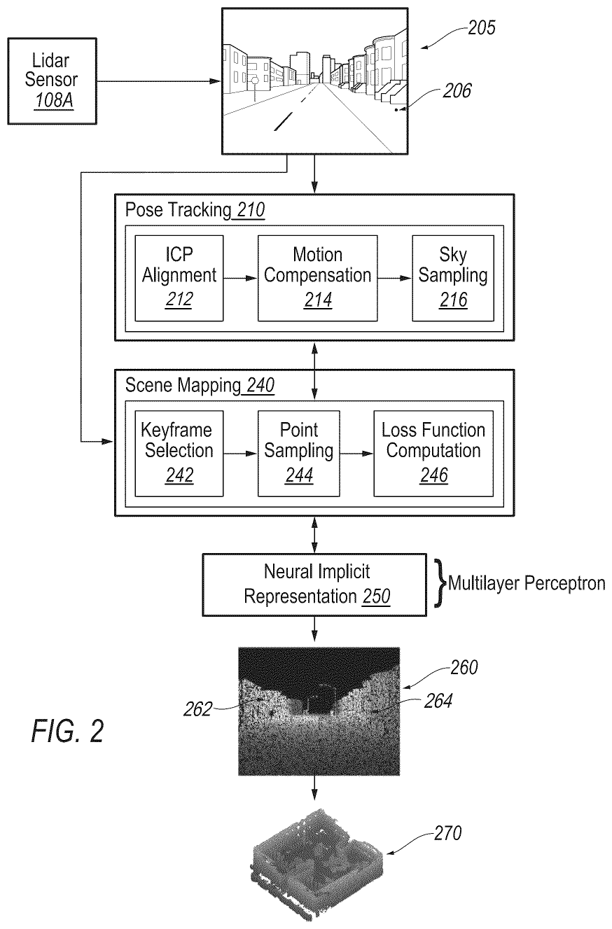

FIG. 2 is a diagram showing processing of lidar sensor measurements and rendering of objects external to lidar sensor 108A. In an example, pose tracking component 210 and scene mapping component 240 represent a set of programming instructions that operate to perform simultaneous location and mapping (SLAM) by dividing location and mapping into two separate processing threads. Accordingly, in the example of FIG. 2, pose tracking component 210 operates to obtain an initial estimate of the pose of lidar sensor 108A. The initial pose estimate can then be used by scene mapping component 240 in a loss computation and optimization operation to reconstruct a scene external to lidar sensor 108A (mounted on vehicle structure 103). Pose tracking component 210 executes programming to implement an iterative closest point (ICP) utilizing successive measurement scans of lidar sensor 108A to obtain an initial pose estimate for keyframes for potential selection at a later time. To reduce motion distortion that may occur in during a side-to-side scan of lidar sensor 108A, which occurs over a nonzero or non-negligible duration during which vehicle 100 is in motion, a motion compensation module can be utilized to remove distortions in measurement points resulting from scanning of lidar measurement points selected to form a keyframe. Measurement points directed toward the sky can be sampled for later use. In this context, a “keyframe” means a set of measurement points resulting from a lidar scan that are periodically or intermittently selected to be used by scene mapping component 240 for loss computation and optimization steps in place of an implicit representation of a set of measurement points. In an example, a set of measurement points resulting from a lidar scan not selected for use in a keyframe are utilized by pose tracking component 210 to obtain initial pose estimation for keyframe lidar scans. Thus, in an example, a keyframe can be constructed from measurement points resulting from a lidar scan from lidar sensor 108A. Scene mapping component 240 operates to reconstruct scene 205, based on the keyframes. Scene mapping component 240 executes an optimization process utilizing a window that includes a current keyframe from pose tracking component 210 and keyframes previously obtained from pose tracking component 210. In this context, a “window” means a set of keyframes gathered or collected over an interval preceding the current keyframe. For example, a window can include a current keyframe and keyframes gathered or collected at a predetermined number (e.g., 4, 5, 7, 9, etc.) of time intervals (e.g., 0.2-second intervals, 0.5-second intervals, 1.0-second intervals, etc.) prior to the current keyframe. In an example, scene mapping component 240 randomly selects previously obtained keyframes from pose tracking component 210 for use during the optimization process. In an implementation, use of randomly selected keyframes versus time-based selection of keyframes operates to increase efficiency in a SLAM process, which can be confirmed by an ablation study. In this context “ablation” means removal of a portion of one or more program steps described in relation to FIG. 2 to determine a contribution of the removed program steps to enhance scene reconstruction and to refine pose estimation.

As illustrated in FIG. 2, lidar sensor 108A may output signal measurements that represent a scene, such as scene 205, for processing in parallel by pose tracking component 210 and scene mapping component 240. In the example of FIG. 2, pose tracking component 210 operates to process a set of points from a measurement scan obtained responsive to lidar sensor 108A scanning scene 205. Pose tracking component 210 can operate to estimate odometry using an iterative closest point (ICP) alignment algorithm (via ICP alignment component 212) to estimate motion of lidar sensor 108A via motion compensation component 214. In the example of FIG. 2, ICP alignment component 212 operates to minimize the difference between two sets of measurement points obtained during measurement scans of lidar sensor 108A. ICP alignment component 212 can operate by first determining a correspondence between measurement points of a first set of measurement points with the measurement points of the second set. In an alignment process, ICP alignment component 212 performs successive iterations until arriving at a minimum distance between corresponding points of the first and second sets of measurement points. Alternatively or in addition, ICP alignment component 212 can operate to minimize the difference between a first set of measurement points and a plane that includes a second set of measurement points.

In an example, use of ICP alignment component 212 permits programming of computer 104 to compensate for movement of lidar sensor 108A as vehicle 100 moves along path 50. In an example, ICP alignment component 212 can utilize an identity transformation as an initial alignment estimate of vehicle 100 with respect to a feature present in scene 205. In response to an alignment estimate, the pose of lidar sensor 108A can be modified to align with a keyframe that represents scene 205 during a measurement interval of lidar sensor 108A or to align with features within the keyframe. Pose tracking component 210 additionally includes sky sampling component 216, which operates to determine whether any region of the lidar scan in which no points were detected by the sensor corresponds to an area of sky, e.g., oriented at a positive angle with respect to lidar sensor 108A. Sky sampling component 216 can additionally operate to reduce or eliminate estimating random noise in sky regions.

Scene mapping component 240, operating in parallel with pose tracking component 210, can utilize output data representing a measurement scan from lidar sensor 108A during current (ongoing) scans and utilizes selected prior scans as keyframes via keyframe selection component 242. In the example of FIG. 2, keyframes can be utilized to update neural implicit representation 250, operating via programming of computer 104. In an example, in which neural implicit representation 250 is a fully connected neural network combined with a multi-level hierarchical feature grid encoding. Updating neural implicit representation 250 can include updating weights of the constituent nodes of the layers (e.g., all layers) of the fully connected neural network and parameters of the multi-level hierarchical feature grid encoding. Point sampling component 244 cooperates with loss function computation component 246 to sample points obtained during lidar measurements scans and to compute a loss between predicted or expected values output from neural implicit representation 250.

In the example of FIG. 2, signal measurements representing points obtained from a measurement scan via lidar sensor 108A can be decimated to a fixed frequency, such as 2 hertz, 5 hertz, 10 hertz, etc. In an example, the relative transform Pᵢ₋₁, i∈SE(3), in which SE(3) indicates both translational and rotational motion in a three-dimensional space from a previous scan to the current scan is estimated using a point-to-plane iterative closest point estimate utilizing ICP alignment component 212. Such an estimate can be later refined via mapping optimization and sky sampling via sky sampling component 216. The pose of lidar sensor 108A (xᵢ∈SE(3)) can then be estimated as \hat{x}ᵢ=\hat{x}ᵢ₋₁·P_{i-1,i}. In response to obtaining previous and current poses, lidar sensor 108A can be motion-compensated utilizing motion compensation component 214 assuming, for example, a constant velocity between motion between scans obtained from lidar sensor 108A.

Scene 205 can be represented as a multilayer perceptron in a hierarchical multilevel feature grid. In an example, a three-dimensional feature grid can be constructed beginning with randomly initialized values spread uniformly through a three-dimensional space. An input X. Y. Z point in a Cartesian coordinate system can be encoded by first determining which cell in the three-dimensional feature grid the input X, Y, Z point falls within. Second, the features on the eight corners of can be linearly interpolated to obtain an output feature. The process can be repeated at differing levels of resolution. The results can be stacked or assembled into one feature vector that represents the feature at the differing levels of resolution. The output vector can then be passed through the multilayer perceptron. Accordingly, the features of the feature grid can be learned and updated via back propagation through the multilayer perceptron of neural implicit representation 250. As previously described, back propagation through the multilayer perceptron can include updating weights of the constituent nodes of the layers (e.g., all layers) of the fully connected neural network. Such processes can operate to provide learned multilevel three-dimensional feature grid encoding.

In an example, during online training, parameters (e.g., Θ of the query [symbol] (sᵢ; Θ)) of the multilayer perceptron and feature grid are updated to predict the volume density (σ) of each measurement point measured during a scan obtained via lidar sensor 108A. In a training exercise, such as to train the multilayer perceptron and to estimate distances to measured points (e.g., point 206), a volumetric rendering procedure can be followed. For example, for a lidar signal (e.g., a ray) can be represented by \vec{r}, having an origin \vec{o}, and direction \vec{d}, an example distance tᵢ∈[tₙₑₐᵣ, t_{far}], which generates Nₛ samples, sᵢ=\vec{o}+tᵢ\vec{d}. In an example, tₙₑₐᵣ and t_{far} can correspond to measurement ranges of lidar sensor 108A (e.g., tₙₑₐᵣ=0.5 meter, 1.0 meter, etc.), while t_{far} (e.g., 100 meters, 200 meters, etc.) can depend on the scale of scene 205. In an example, the feature grid and multilayer perceptron, which may collectively be referred to as [symbol] (sᵢ; Θ), can be queried to predict the occupancy state σᵢ. In an example, transmittances Tᵢ and weights wᵢ of a measurement point (e.g., point 206) can be computed in accordance with expressions (1) and (2), below:

$${T}_{i} = {e}^{- {\sum }_{j = 1}^{i - 1} {σ}_{j} {δ}_{j}} \qquad ( 1 )$$

$${w}_{i} = {T}_{i} {σ}_{i} \qquad ( 2 )$$

where δⱼ=tⱼ₊₁−tⱼ, and σᵢ is the expected volume density at sample sᵢ as predicted by the multilayer perceptron. The weights wᵢ are used by a loss function (e.g., computed by loss function computation component 246) to represent a probability that a measurement point (e.g., 206) of a ray (e.g., transmitted via lidar sensor 108A) is predicted or expected (e.g., by the multilayer perceptron) to terminate at the predicted or expected measurement point. Accordingly, the expected termination distance of a ray \hat{D}(\vec{r}) can be estimated in accordance with expressions (3), below:

$$\hat{D} ( \vec{r} ) = {\sum }_{i = 1}^{N} {w}_{i} {t}_{i} \qquad ( 3 )$$

where the weights w; correspond to weights utilized by a loss function, and where tᵢ∈[tₙₑₐᵣ, t_{far}]. Scene mapping component 240 operates to receive scanning lidar measurements (conducted by lidar sensor 108A) from pose tracking component 210. Scene mapping component 240 operates to determine whether to form a keyframe. In an example, in response to an optimization window of keyframes being selected (e.g., randomly selected), scene mapping component 240 operates on the optimization window to jointly optimize the neural implicit representation and the estimated pose of each keyframe in the optimization window. In an example, keyframes are selected by keyframe selection component 242 on a temporal basis, meaning that in response to a predetermined time elapsing since acceptance of the previous keyframe, keyframe selection component 242 adds the new keyframe. In response to acceptance of a new keyframe, scene mapping component 240 can update an optimizer operating via programming of keyframe selection component 242 based on the accepted new keyframe and previously accepted keyframes. In an example, N_{w} total keyframes are used in an update, including the new accepted keyframe along with N_{w}−1 randomly selected previous keyframes.

In an example, in response to a window of keyframes being selected (e.g., randomly selected), scene mapping component 240 uses keyframe and past keyframes to jointly optimize the pose of the lidar sensor and the neural implicit representation. In this context, and “optimization window” means the N_{w} total keyframes selected. In an example, for a keyframe KFᵢ having an estimated pose \hat{x}ᵢ in a global reference frame, a twist vector \hat{ξ}ᵢ∈ [symbol] ⁶, in which the notation [symbol] ⁶ indicates three values that express angular rotational velocity (e.g., with respect to a pitch axis, a roll axis, a yaw axis, or in another coordinate frame) and values vectors expressing translational velocity (e.g., with respect to the X axis, the Y axis, and the Z axis, or in another coordinate frame). In an example, for \hat{ξ}ᵢ=(\hat{ω}ᵢ, \hat{υ}ᵢ). \hat{ω}ᵢ represents both the axis-angle representation of the rotation component of the estimated pose (\hat{x}ᵢ), and \hat{υ}ᵢ and represents the translational component. In a forward pass through scene mapping component 240, the twist vector (\hat{ξ}ᵢ) can be converted back into a pose (\hat{x}ᵢ) and be utilized in the computation of the origin of signals transmitted via lidar sensor 108A. In an example, a set of points (N_{R}) from a measurement scan obtained by lidar sensor 108A can be sampled at random to provide N_{S} distance samples representing each ray using an occupancy grid.

Loss function computation component 246 utilizes dynamic margin loss, which is combined with depth loss and sky loss in accordance with expression (4), below:

$$ℒ ( Θ ) = {ℒ}_{JS} + {λ}_{1} {ℒ}_{depth} + {λ}_{2} {ℒ}_{sky} \qquad ( 4 )$$

where [symbol] _{JS} represents a dynamic margin loss computed using the Jensen-Shannon divergence, and wherein [symbol] _{depth} and [symbol] _{sky} represent depth and sky loss for lidar measurement points in response to a transmitted signal from a lidar sensor (e.g., 108A). The constants λ₁ and λ₂ represent positive weight values. In an example, λ₁ and λ₂ can be assigned an integer value (e.g., 1, 2, 3, 5, etc.) or can be assigned a floating-point value (e.g., 0.1, 0.2, 1.1, 1.2, etc.). In an example, loss computed via the Jenson-Shannon divergence of expression (4) operates to compute a dynamic margin for lidar measurement points in response to a transmitted signal from lidar sensor 108A. In an example, use of a dynamic margin loss enhances training convergence and reconstruction accuracy.

In a typical formulation of a loss function, a single margin is utilized for lidar measurement points in response to a transmitted signal from a lidar sensor (e.g., 108A). In contrast, expression (4) permits assignment of a unique (e.g., dynamic) margin correlated with the variance or standard deviation of a training distribution centered at each point. Accordingly, for each ray (\vec{r}) terminating at a measurement point in response to a transmitted signal from a lidar sensor (e.g., 108A), samples obtained along the ray can be expressed as sᵢ=\vec{o}+tᵢ\vec{d}, and z*, which operates to represent the measured distance for each ray (\vec{r}). As previously discussed, \vec{o} represents the origin of a ray terminating at a measuring point having a direction \vec{d}. tᵢ represents the distance of individual training samples along the ray (\vec{r}). In this context, a truncated Gaussian distribution ( [symbol] _{ε}) having a bounded domain that is parameterized by relatively low margin correlated with the variance or standard deviation of a training distribution centered at a learned point. In an example the margin (ε), with [symbol] _{ε}= [symbol] (0, (ε/3)²) (i.e., standard deviation of ε/3) as a training distribution, wherein the margin ε/3 represents an example of a relatively low margin. In other examples, other margins could be utilized, such as ε/2, ε/4, ε/5, etc. Thus, target weights can be expressed as ω*ᵢ= [symbol] _{ε}(tᵢ−z*). In such an example, the Jensen-Shannon loss function can be expressed in accordance with expression (5), below:

$${ℒ}_{JS} ( Θ ) = {‖ {ω}_{i}^{*} - {ω}_{i} ‖}_{1} + {‖ 1 - {\sum }_{i} {ω}_{1} ‖}_{1} \qquad ( 5 )$$

where the quantity ∥ω*ᵢ−ωᵢ∥₁ represents a primary loss and wherein the quantity ∥1−Σᵢω₁∥₁ represents an opacity loss. In an example, the opacity loss provides a means of weighting each ray so as to maintain a sum of 1.0 or less. The Jensen-Shannon loss function of expression (5) is thus computed based on a combination of primary loss and opacity loss of points of a set of lidar measurement points of a scene.

In applications that perform simultaneous localization and mapping (SLAM), continuous optimization, sparse sampling, and incremental inputs from lidar sensors (e.g., lidar sensor 108A) different regions of a scene can be learned (e.g., by neural implicit representation 250) at varying rates during online training. For example, in an image reconstructed (e.g., image 260) from lidar measurements, scans of scene 205 region 262 may be learned at a different rate than region 264. Mesh representation 270 can be generated via lidar sensor 108A transmitting signals followed by sampling measurement points along the transmitted signals to form queries to neural implicit representation 250. Responsive to the queries, neural implicit representation 250 can estimate the weight (wᵢ) with a value of between 0 and 1 for each sample. Next, a threshold can be set to classify free and occupied space according to the weight (wᵢ) of samples to generate the mesh representation 270.

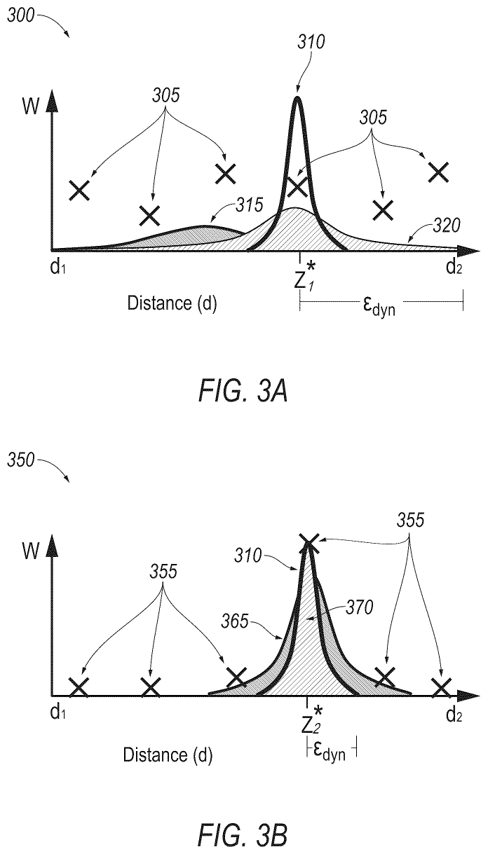

As described in reference to FIGS. 3A and 3B (hereinbelow), use of the Jensen-Shannon loss function permits assignment of a relatively high margin (ε) for rays terminating at a lidar measurement point of a scene having unknown geometry, while a relatively small margin (ε) can be assigned to rays terminating at a measurement point of the scene having known or learned geometry. Such assignment of a high margin/low margin permits neural implicit representation 250 to learn new regions while preserving and refining learned geometry. In an example, in response to a plurality of rays terminating at a measurement point having a relatively small margin may be utilized in a keyframe generated for use by scene mapping component 240. Scene mapping component 240 can then generate a pose of the lidar sensor based on updated (learned) weights of neural implicit representation 250 based on the generated keyframe.

In a backward pass, through scene mapping component 240, a loss function can be computed using weights of neural implicit representation 250. Gradients (e.g., gradient descent) can be computed for neural implicit representation 250, feature grid parameters Θ, and twist vectors \hat{ξ}ᵢ to reduce a magnitude of the loss function. In response to optimization being completed, the optimized twist vectors ξ*ᵢ are converted into SE(3) transformation matrices x*ᵢ. Scene mapping component 240 transmits the transformation matrices (x*ᵢ) to pose tracking component 210 so that future tracking can be executed relative to optimized poses.

Mesh representation 270 can assist in visualizing and computing metrics related to accuracy of scene representations generated by scene mapping component 240. Mesh representation 270 can be generated from the geometry of scene 205 as learned by neural implicit representation 250, which can involve emulating lidar sensor 108A placed at estimated keyframe poses. Neural implicit representation 250 can compute weights along rays terminating at lidar measurement points, which can then be approximated in a 3D grid. In response to multiple weights being present within the same grid cell, the maximum value of the multiple weights can be retained. A computer graphics algorithm can then be used to form a mesh from the result. In an example, such a process can be run offline for visualization and evaluation that are aside from processing steps performed by computer 104.

In an example, the Jensen-Shannon loss function (described in reference to expressions (6) and (7) below) can be utilized to measure the discrepancy between a goal distribution and a sample distribution for lidar measurement points in response to a transmitted signal from a lidar sensor (e.g., 108A). For example, learned regions can have similar goal and sample distributions, which result in smaller Jensen-Shannon divergence between the goal and sample distributions. Accordingly, FIG. 3A is a graph (300) showing sample weights 305 resulting from a query to a neural implicit representation and distances with respect to an unlearned measurement point. The vertical axis of FIG. 3A indicates weights (w) predicted by neural implicit representation 250 of a ray terminating at a lidar measurement point with respect to a distance (d) from lidar sensor 108A. Goal distribution 310 represents a distribution G= [symbol] (z*,σ*), where σ* has been assigned a minimum value of εₘᵢₙ/3. In addition, a sample distribution (e.g., 315) can be defined, as represented by S= [symbol] (μ̅_{w}, σ̅_{w}) where μ̅ and σ̅ represent mean and standard deviations of the predicted weights (e.g., predicted by neural implicit representation 250) along a ray terminating in a lidar measurement point. The dynamic margin (ε_{dyn}) can then be defined in accordance with expression (6), below:

$${ε}_{dyn} = {ε}_{min} ( 1 + α {J}^{*} ) \qquad ( 6 )$$

$$where$$

$${J}^{*} = \{ \begin{matrix}0 & for JS ( G ‖ S ) < {JS}_{min} \\ {JS}_{min} & for JS ( G ‖ S ) < {JS}_{max} \\ JS ( G ‖ S ) & otherwise\end{matrix} \qquad ( 7 )$$

where α represents a constant scaling parameter. In an example, α can be assigned an integer value (e.g., 1, 2, 3, 5, etc.) or a floating-point value (e.g., 0.1, 0.2, 1.1, 1.2, etc.). During a training process, which may operate to enhance convergence between goal distribution 310 (e.g., G= [symbol] (z*,σ*) having a minimum standard deviation of ε_{min}/3) and sample distribution 315 (e.g., S= [symbol] (μ̅_{w}, σ̅_{w}) represents the normal distribution approximation of the weights computed by neural implicit representation 250. In the expression S= [symbol] (μ̅_{w}, σ̅_{w}), μ̅_{w} represents the mean of the weights and σ̅_{w} represents the standard deviation of the weights. JSₘₐₓ of expression (7) can represent an upper bound of the Jensen-Shannon (JS) score, and JSₘᵢₙ represents a threshold for scaling. In response to determining that the JS score is smaller than JSₘᵢₙ, ε_{dyn} can be set equal to εₘᵢₙ.

In the example of FIG. 3A, each of sample weights 305 represents a response to a query (e.g., [symbol] (sᵢ; Θ)) initiated by point sampling component 244 and transmitted to neural implicit representation 250. In response to a query, neural implicit representation 250 transmits a value to indicate a probability that a ray terminates at a lidar measurement point of sample distribution 315 is located a distance (d) from lidar sensor 108A. As shown in FIG. 3A, sample weights 305 returned or predicted by neural implicit representation 250 appear to be relatively evenly distributed between distance d₁ and distance d₂. Such relatively even distribution of sample weights 305 returned by neural implicit representation 250 indicate low confidence in a capability of neural implicit representation 250 to predict a distance between lidar sensor 108A and, for example, a static object within the field of view of lidar sensor 108A. Such a low confidence in a capability for neural implicit representation 250 to predict a distance between lidar sensor 108A and measurement point Z₁* indicates that for a given sample distribution (e.g., sample distribution 315), neural implicit representation 250 is not yet capable of accurately predicting a termination distance from lidar sensor 108A to the set of points of sample distribution 315.

FIG. 3A also depicts training distribution 320 (e.g., S= [symbol] (μ̅_{w}, σ̅_{w})). Training distribution 320 represents a distribution of training samples that operate to train neural implicit representation 250 to achieve goal distribution 310. Such training may involve successive iterations of sampling a training distribution, obtaining predicted distances and weights from neural implicit representation 250, computing a loss function, updating weights of neural implicit representation 250, and resampling the training distribution.

FIG. 3B is a graph (350) showing sample weights resulting from a query to a neural implicit representation and distances with respect to a learned measurement point Z₂*. Similar to that of FIG. 3A, the vertical axis of FIG. 3B indicates weights (w) predicted by neural implicit representation 250 of a ray terminating at a lidar measurement point (Z₂*) with respect to a distance (d) from lidar sensor 108A. In response to a query, neural implicit representation 250 transmits a value to indicate a probability that a measurement point of a ray represented by of sample distribution 365 is located a distance (d) from lidar sensor 108A. Thus, in an example, each of sample weights 355 represents a response to a query initiated by scene mapping component 240 and transmitted to neural implicit representation 250. In response to a query, neural implicit representation 250 transmits a value to indicate a probability that a ray terminates at a lidar measurement point located a distance (d) from lidar sensor 108A. In FIG. 3B, a dynamic margin (¿) has been set for training distribution 370, thus permitting refinement of expected or predicted distances to measurement point Z₂* by neural implicit representation 250. Accordingly, by way of expression (7) neural implicit representation 250 has learned to accurately predict a termination distance from lidar sensor 108A to the set of points in training distribution 320, such as measurement point Z₂*.

Accordingly, in reference to FIGS. 3A and 3B, use of the Jensen-Shannon loss function operates to set a dynamic margin ε for each ray as represented by measurement point depending on the similarity between training distribution 320 and goal distribution 310. The Jensen-Shannon loss function operates to provide a scaled training distribution that sets a higher margin (ε_{dyn}) for measurement points of rays terminating in unlearned regions and sets a lower margin for rays terminating in learned regions so as to refine neural implicit representation 250 to enhance convergence between training distribution 320 and goal distribution 310. In an example, expression (7) operates to assign a minimum to an unlearned measurement point (e.g., point Z₁*) responsive to the assigned being less than a first threshold value and to assign a maximum value to a measurement point (e.g., Z₂*) responsive to the assigned being greater than a second threshold value.

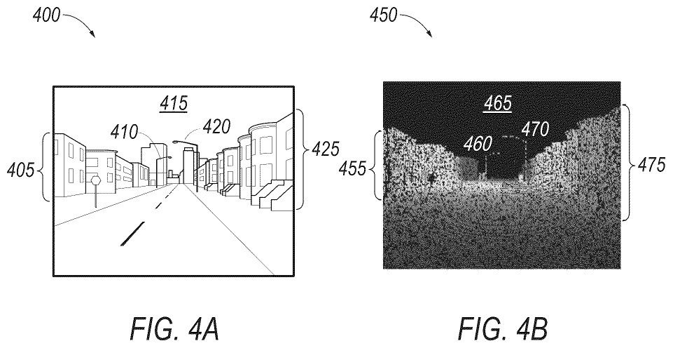

FIG. 4A depicts a scene external to a lidar measurement system. As shown in FIG. 4A, scene 400 corresponds to a city traffic scene. Buildings 405 are depicted at a left portion of scene 400 while buildings 425 are depicted at a right portion of scene 400. Street lampposts 410, 420 are also depicted along with sky 415, which is depicted at a positive elevation angle in a global reference frame with respect to lidar sensor 108A.

FIG. 4B is a representation of the image of FIG. 4A obtained via lidar measurement points. In an example, reconstructed scene 450 depicts a reconstructed image obtained via lidar sensor 108A. In an example that utilizes the processing of lidar sensor measurements and neural implicit representation 250, point representations of buildings 405 are shown as reconstructed buildings 455 at the left portion of reconstructed scene 450. Point representations of buildings 425 are depicted at a right portion of reconstructed scene 450 as buildings 475. It may be appreciated that street lamppost 410 and lamppost 420 have been accurately rendered in reconstructed scene 450 (e.g., reconstructed lampposts 460 and 470).

Reconstructed scene 450 additionally shows sky 465, which may be reconstructed as described in reference to FIGS. 1, 2, 3A and 3B. In addition, as previously described in reference to expression (4), depth loss for a ray terminating at a lidar measurement point is utilized as an additional term in computing the loss function for the ray. In this context, a depth loss means a difference between a termination distance of a ray predicted or expected by neural implicit representation 250 and an actual termination distance of the ray as measured by lidar sensor 108A. The depth loss can be computed in accordance with expression (8), below:

$${ℒ}_{depth} ( Θ ) = {‖ \hat{D} ( \vec{r} ) - {z}^{*} ‖}_{2}^{2} \qquad ( 8 )$$

where \hat{D}(\vec{r}) and z* are described in reference to expressions (3) and (4), and where the subscript “2” of expression (8) denotes the L2 (Euclidean) norm. In some instances, depth loss can contribute to a blurry reconstruction with limited training time. However, in some instances, depth loss can provide hole-filling in which a collection of points of a detected geometry appears to surround one or more points for which a return signal from a lidar sensor (e.g., 108A) is absent. In an example, depth loss can be deemphasized, such as by setting a weight (e.g., λ₁ of expression (4)) to a small value, such as a value of between about 10⁻⁵ and about 10⁻⁶. In an example, scene mapping component 244 may assign a zero weight to any point of a set of measurement points based on an absence of a returned signal received in response to a signal transmitted during a measurement scan by lidar sensor 108A.

Also as described previously in reference to expression (4), sky loss for a ray terminating at a lidar measurement point is utilized as an additional term in computing the loss function for the ray. In an example, sky loss can be determined by observing holes in measurements scans of a scene (e.g., scene 400) obtained via lidar sensor 108A. In an example, each scan can be converted to a depth image. The image can then be filtered via applying a small number (e.g., less than 10) of dilate and erode operations. Any points that remain empty may reflect regions of the lidar scan where no return has been received. In an example, in response to a ray terminating at a lidar measurement point that includes a positive elevation angle in a global reference frame, the ray may be determined as pointing toward the sky of the scene based on the lidar sensor (108A) being level with the ground. In an example, for rays terminating at a lidar measurement point determined to be pointing toward a skyward region of a scene, then for all such rays, sky loss can be computed in accordance with expression (9), below:

$${ℒ}_{sky} ( Θ ) = {‖ w ‖}_{1} \qquad ( 9 )$$

Accordingly, reconstructed scene 450 can accurately depict sky 415 of scene 400. In an example, w of expression (9) can be assigned a weight of 0 in response to an absence of a return lidar signal transmitted during a measurement scan of lidar sensor 108A.

The techniques herein utilize neural implicit representation 250 to extract geometry data from scene 205, 400. In response to training of the neural implicit representation 250 receives output signals from lidar sensor 108A of points within scene 205, 400 during a measurement scan of lidar sensor 108A. Over time, programming of computer 104 implements the neural implicit representation to continuously or intermittently train and refine neural implicit representation 250 as vehicle 100 proceeds along path 50.

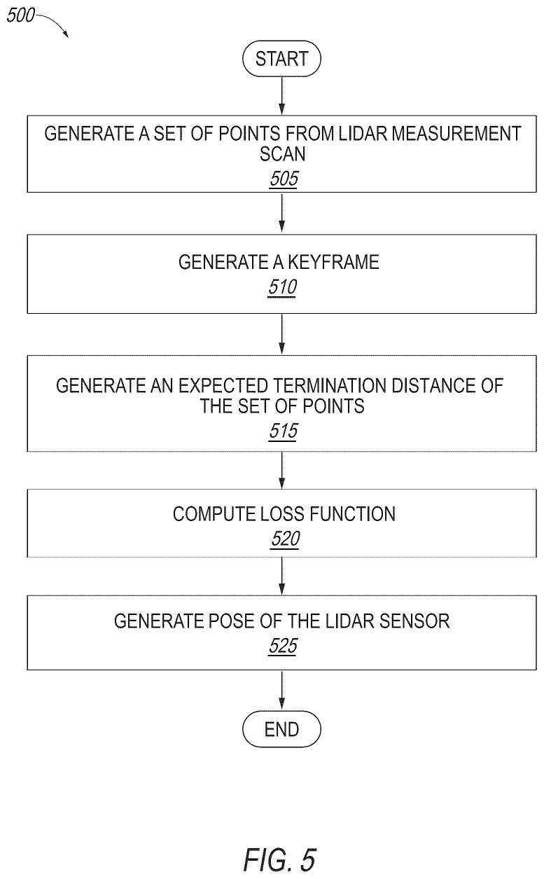

FIG. 5 is a flowchart for process 500 for generating pose via lidar measurements. The memory of computer 104 stores executable instructions for performing the steps of process 500 and/or programming can be implemented in structures such as mentioned above. Process 500 may begin in response to vehicle 100 turning on or being shifted out of park into a driving gear. As a general overview of process 500, computer 104 receives data from lidar sensor 108A and may initialize an occupancy grid map. Computer 104 can independently train neural implicit representation 250 for a preset number of iterations. For each measurement point obtained during a scan of lidar sensor 108A, computer 104 can compute transmittance of (Tᵢ) and weights of a measurement point (wᵢ) in accordance with expressions (1) and (2). Computer 104 can additionally estimate an expected termination distance of a ray (\hat{D}(\vec{r})) utilizing expression (3) and estimate termination distances of a ray representing measurement point. Computer 104 can additionally compute the dynamic loss margin ( [symbol] (Θ)) in accordance with expression (4). In an example, the loss function can be a Jensen-Shannon loss function ( [symbol] _{JS}(Θ)) in accordance with expression (5). In computing the Jensen-Shannon loss function, computer 104 can compute a dynamic margin (ε_{dyn}) in accordance with expressions (6) and (7). Computer 104 may additionally compute depth loss ( [symbol] _{depth}(Θ)) in accordance with expression (8) and sky loss ( [symbol] _{sky}(Θ)=∥w∥₁) in accordance with expression (9).

Process 500 begins at block 505, which can include generating a set of points from a measurement scan obtained by lidar sensor 108A. In an example, lidar sensor 108A may include a scanning lidar sensor mounted to vehicle 100 that performs continuous side-to-side (e.g., left to right) scanning of an environment external to vehicle 100. Lidar sensor 108A may include a vertical stack of lidar sensors so as to obtain data regarding numerous measurement points in a single side-to-side scan.

Process 500 continues at block 510, which may include generating an expected termination distance to a set of measurement points based on output signals from neural implicit representation 250 of the set of measurement points. In an example, such as that of FIGS. 3A and 3B, an expected termination distance corresponds to sample weights 305, returned by neural implicit representation 250, distributed between distance d₁ and d₂ from lidar sensor 108A.

Process 500 continues at block 515, which may include computing a loss function that includes a relatively low (ε), such as indicated in FIG. 3A, assigned to a point (e.g., Z₂*) of the set of points, such as sample points represented by sample weights 305 based on the expected termination distance of the point (e.g., Z₂*) responsive to the point (e.g., Z₂*) being previously learned by the neural implicit representation 250.

Process 500 continues at block 520, which includes generating a keyframe from the set of points. As described in reference to FIG. 3B, a keyframe may be generated in response to a plurality of rays terminating at a measurement point having relatively small margin.

Process 500 continues at block 525, which includes generating a pose of lidar sensor 108A based on updated weights of the neural implicit representation based on the keyframe.

After block 525, process 500 ends.

In an example, in response to generating a pose of lidar sensor 108A, computer 104 may actuate one or more of the propulsion system of vehicle components 110, a steering system of components 110, or HMI 112. For example, computer 104 may actuate one or more of components 110 utilizing executing an advanced driver assistance system (ADAS). ADAS are electronic technologies that assist drivers in driving and parking functions. Examples of ADAS include lane-departure detection, blind-spot detection, adaptive cruise control, and lane-keeping assistance. Computer 104 may actuate a system of vehicle 100 to stop the vehicle before reaching an object in the environment, according to an algorithm that operates without human input. Computer 104 may operate vehicle 100 autonomously, i.e., the propulsion system, and/or the steering system, based on output signals from neural implicit representation 250.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above and can be accessed via a network in any one or more of a variety of manners. A file system may be accessible from a computer operating system and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It should further be understood that certain steps could be performed simultaneously, that other steps could be added, or that certain steps described herein could be omitted. Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. The adjectives “first” and “second” are used throughout this document as identifiers and are not intended to signify importance, order, or quantity. Use of “in response to” and “upon determining” indicates a causal relationship, not merely a temporal relationship. Many modifications and variations of the present disclosure are possible in light of the above teachings, and the disclosure may be practiced otherwise than as specifically described.

What is claimed is:

1. A system, comprising:
a computer that includes a processor and a memory, the memory including instructions executable by the processor to:
generate a set of points from a measurement scan obtained by a lidar sensor;
generate an expected termination distance of the set of points based on a neural implicit representation of the set of points;
compute a loss function that includes a relatively low margin correlated with a variance or standard deviation of a training distribution centered at a learned point of the set of points based on the expected termination distance of the learned point, the learned point being learned by the neural implicit representation;
generate a keyframe from the set of points; and
generate a pose of the lidar sensor based on the keyframe.

2. The system of claim 1, wherein the instructions to generate the pose of the lidar sensor additionally include instructions to:
modify the pose of the lidar sensor to align with the neural implicit representation of the set of points.

3. The system of claim 1, wherein the instructions to compute the loss function includes instructions to:
assign a relatively high margin correlated with a variance or standard deviation of a training distribution centered at an unlearned point of the set of points based on the unlearned point being unlearned by the neural implicit representation.

4. The system of claim 1, wherein the instructions are additionally to:
transmit the generated pose of the lidar sensor to an autonomous vehicle driving application.

5. The system of claim 4, wherein the instructions are additionally to:
execute motion planning by the autonomous vehicle driving application based on the generated pose.

6. The system of claim 1, wherein computed loss is based on a combination of primary loss and opacity loss of the learned point.

7. The system of claim 1, wherein the instructions to compute the loss function include instructions to compute a depth loss of the learned point, the depth loss representing a difference between an expected distance of the learned point based on the neural implicit representation and a distance extracted from the measurement scan.

8. The system of claim 1, wherein the instructions to compute the loss function includes instructions to:
compute a gradient of the loss function; and
utilize the computed gradient to update generated pose estimates and weights of the neural implicit representation via gradient descent to reduce a magnitude of the loss function.

9. The system of claim 1, wherein the instructions are additionally to:
compute the margin for the learned point based on the neural implicit representation of the learned point and a weight of the learned point derived from the measurement scan.

10. The system of claim 9, wherein the instructions are additionally to:
assign a minimum margin to the learned point responsive to the assigned margin being less than a first threshold value.

11. The system of claim 9, wherein the instructions are additionally to:
assign a maximum margin to the learned point responsive to the assigned margin being greater than a second threshold value.

12. The system of claim 1, wherein the instructions are additionally to:
assign a zero weight to any point of the set of points based on an absence of a returned signal received in response to a signal transmitted during the measurement scan.

13. The system of claim 1, wherein the instructions are additionally to:
generate a mesh representation of the measurement scan based on the neural implicit representation of the set of points.

14. The system of claim 1, wherein the neural implicit representation includes a continuous function that represents three-dimensional scene geometry.

15. The system of claim 14, wherein the neural implicit representation includes expected weights along rays terminating at the set of points.

16. A method, comprising:
generating a set of points from a measurement scan obtained by a lidar sensor;
generating an expected termination distance of the set of points based on a neural implicit representation of the set of points;
computing a loss function that includes a relatively low margin correlated with a variance or standard deviation of a training distribution centered at a learned point of the set of points based on the expected termination distance of the learned point, the learned point being learned by the neural implicit representation;
generating a keyframe from the set of points; and
generating a pose of the lidar sensor based on the keyframe.

17. The method of claim 16, further comprising:
assigning a relatively high margin correlated with a variance or standard deviation of a training distribution centered at an unlearned point of the set of points based on the unlearned point being unlearned by the neural implicit representation.

18. The method of claim 16, further comprising:
transmitting the updated pose of the lidar sensor to an autonomous vehicle driving application.

19. The method of claim 18, further comprising:
executing motion planning by the autonomous vehicle driving application based on the generated pose.

20. The method of claim 16, further comprising:
assigning a zero weight to any point of the set of points based on an absence of a returned signal received in response to a signal transmitted during the measurement scan.
